(19) United States
(12) Patent Application Publication
(10) Pub. No.: US 2022/0353937 A1
(43) Pub. Date: Nov. 3, 2022

(54) MULTI-ACCESS PDU SESSION ESTABLISHMENT ABNORMAL HANDLING

(71) Applicant: MEDIATEK INC., Hsin-Chu (TW)

(72) Inventors: Yuan-Chieh Lin, Hsin-Chu (TW); Chi-Hsien Chen, Hsin-Chu (TW)

(21) Appl. No.: 17/706,496

(22) Filed: Mar. 28, 2022

Related U.S. Application Data
(60) Provisional application No. 63/181,384, filed on Apr. 29, 2021.

(51) Int. Cl. H04W 76/16; H04W 76/18; H04W 76/19; H04W 76/30

(52) U.S. Cl. CPC H04W 76/16; H04W 76/18; H04W 76/19; H04W 76/30

(57) ABSTRACT

A method for handling a collision of a UE-requested MA PDU session establishment procedure and a network-requested MA PDU session release procedure is proposed. If the UE-requested PDU session establishment procedure is to establish user plane resources on a second access type for an MA PDU session on a first access and the Access type IE is not included in the PDU SESSION RELEASE COMMAND or the Access type IE included in the PDU SESSION RELEASE COMMAND indicates the first access, then the UE proceeds with the network-requested PDU session release procedure for releasing the MA PDU session, and aborts the UE-requested PDU session establishment procedure.

### CROSS REFERENCE TO RELATED APPLICATIONS

This application claims priority under 35 U.S.C. § 119 from U.S. Provisional Application No. 63/181,384, entitled “MA PDU Establishment Abnormal Handling”, filed on Apr. 29, 2021, the subject matter of which is incorporated herein by reference.

### TECHNICAL FIELD

The disclosed embodiments relate generally to wireless communication, and, more particularly, to method for handling multi-access (MA) PDU session establishment when UE receives PDU session release command from the network.

### BACKGROUND

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. The next generation mobile network (NGMN) board, has decided to focus the future NGMN activities on defining the end-to-end requirements for 5G new radio (NR) systems.

In 5G/NR, a protocol data unit (PDU) session defines the association between the UE and the data network that provides a PDU connectivity service. The PDU session establishment is a parallel procedure of PDN connection (bearer) procedure in 4G/LTE. Each PDU session is identified by a PDU session ID (PSI), and may include multiple QoS flows and QoS rules. Each PDU session can be established via a 5G access network (e.g., 3GPP radio access network (RAN), or via a non-3GPP RAN). The network/UE can initiate different PDU session procedures, e.g., PDU session establishment, PDU session modification, and PDU session release, for managing PDU sessions.

Operators are seeking ways to balance data traffic between mobile networks and non-3GPP access in a way that is transparent to users and reduces mobile network congestion. In 5GS, UEs can be simultaneously connected to both 3GPP access and non-3GPP access (using NAS signalling), thus the 5GS is able to take advantage of these multiple accesses to improve the user experience and optimize the traffic distribution across various accesses. Accordingly, 3GPP introduced Multi-Access (MA) PDU session in 5GS. An MA PDU session can be configured to use one 3GPP access network or one non-3GPP access network at a time, or simultaneously one 3GPP access network and one non-3GPP access network.

MA PDU sessions can be established over both 3GPP access and non-3GPP access simultaneously, or one at a time. For established MA PDU sessions, the 5GS can initiate a PDU session release procedure to release one specific access type or both access types for an MA PDU session. However, when a UE-requested MA PDU session establishment procedure and a network-requested MA PDU session release procedure collide, UE behavior is undefined.

A solution is sought.

### SUMMARY

A method for handling a collision of a UE-requested MA PDU session establishment procedure and a network-requested MA PDU session release procedure is proposed. The collision is detected if the UE receives a PDU SESSION RELEASE COMMAND message after sending a PDU SESSION ESTABLISHMENT REQUEST message to the network, and the PDU session ID (PSI) in the PDU SESSION RELEASE COMMAND message is the same as the PDU session ID in the PDU SESSION ESTABLISHMENT REQUEST message. If the UE-requested PDU session establishment procedure is to establish user plane resources on a second access type for an MA PDU session already established on a first access and the Access type IE is not included in the PDU SESSION RELEASE COMMAND or the Access type IE included in the PDU SESSION RELEASE COMMAND indicates the first access, then the UE proceeds with the network-requested PDU session release procedure for releasing the MA PDU session, and aborts the UE-requested PDU session establishment procedure. Otherwise, the UE ignores the PDU SESSION RELEASE COMMAND message and proceeds with the UE-requested PDU session establishment procedure to establish the MA PDU on the second access.

In one embodiment, a UE maintains a multi-access protocol data unit (MA PDU) session in a 5G system (5GS). The MA PDU session has a PDU session ID (PSI) and user plane resources of the MA PDU session are established over a first access type. The UE transmits a PDU session establishment request message for a UE-requested PDU session establishment procedure for the MA PDU session. The PDU session establishment request message is sent to the 5GS over a second access type. The UE receives a PDU session release command message for a network-requested PDU session release procedure for the same MA PDU session. A PSI in the received PDU session release command message is the same as the PSI in the transmitted PDU session establishment request message. The UE detects a collision between the UE-requested PDU session establishment procedure and the network-requested PDU session release procedure (the PDU session ID in the PDU session release command message is the same as the PDU session ID in the PDU session establishment request message). The UE proceeds with the network-requested PDU session release procedure when a conflict condition is satisfied, and aborts the UE-requested PDU session establishment procedure.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G network supporting multi-access (MA) protocol data unit (PDU) session management and a method for MA PDU session establishment abnormal handling in accordance with one novel aspect.

FIG. 2 illustrates simplified block diagrams of a user equipment (UE) and a network entity in accordance with embodiments of the current invention.

FIG. 3 illustrates one embodiment of MA PDU session establishment handling when UE also receives a PDU session release command from the network in accordance with one novel aspect.

FIG. 4 illustrates another embodiment of MA PDU session establishment handling when UE also receives a PDU session release command from the network in accordance with one novel aspect.

FIG. 5 is a flow chart of a method of handling MA PDU session establishment in accordance with one novel aspect of the present invention.

### DETAILED DESCRIPTION

Reference will now be made in detail to some embodiments of the invention, examples of which are illustrated in the accompanying drawings.

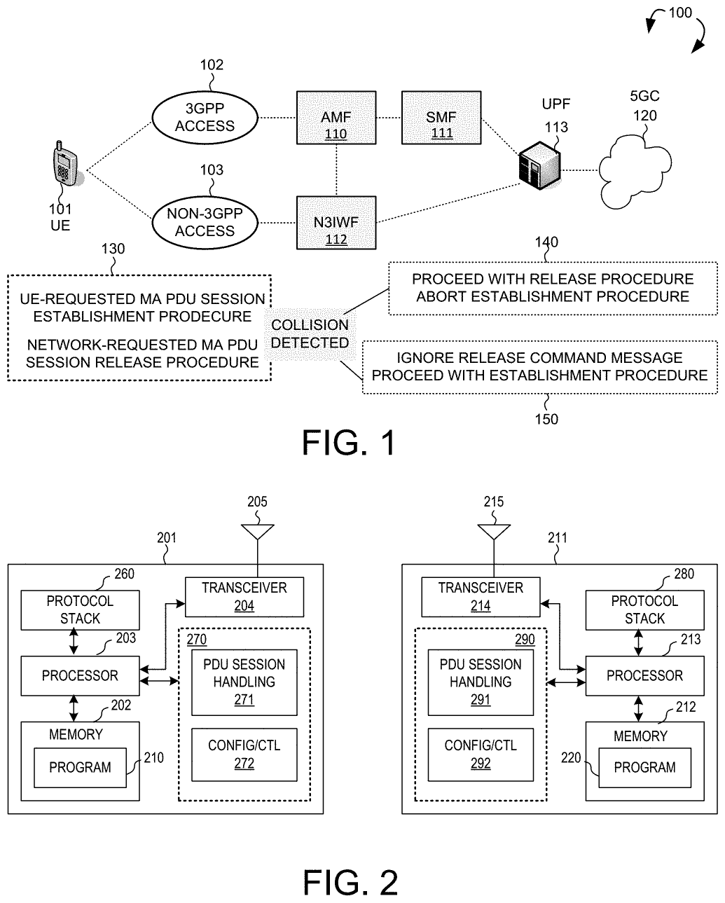

FIG. 1 illustrates an exemplary 5G network 100 supporting multi-access (MA) protocol data unit (PDU) session management and MA PDU session establishment abnormal handling in accordance with one novel aspect. 5G new radio (NR) network 100 includes a user equipment (UE) 101, a 3GPP access 102 (e.g., a 3GPP radio access network (RAN)), a non-3GPP access 103 (e.g., a non-3GPP RAN), an access and mobility management function (AMF) 110, a session management function (SMF) 111, an Non-3GPP interworking function (N3IWF) 112, a user plane function (UPF) 113, and a 5G core (5GC) data network 120. The AMF 110 communicates with the base stations in the 3GPP access 102, the SMF 111, and the UPF 113 for access and mobility management of wireless access devices in the 5G network 100. The SMF 111 is primarily responsible for interacting with the decoupled data plane, creating, updating and removing PDU sessions and managing session context with the UPF 113. The N3IWF 112 interfaces to 5G core network control plane functions, responsible for routing messages outside 5G RAN.

In Access Stratum (AS) layer, an RAN provides radio access for the UE 101 via a radio access technology (RAT). In Non-Access Stratum (NAS) layer, the AMF 110 and the SMF 111 communicate with RAN and 5GC for access and mobility management and PDU session management of wireless access devices in the 5G network 100. The 3GPP access 102 may include base stations (gNBs or eNBs) providing radio access for the UE 101 via various 3GPP RATs including 5G, 4G, and 3G/2G. The non-3GPP access 103 may include access points (APs) providing radio access for the UE 101 via non-3GPP RAT including WiFi. The UE 101 can obtain access to data network 120 through 3GPP access 102, AMF 110, SMF 111, and UPF 113. The UE 101 can obtain access to data network 120 through non-3GPP access 103, N3IWF 112, AMF 110, SMF 111, and UPF 113. The UE 101 may be equipped with a single radio frequency (RF) module or transceiver or multiple RF modules or transceivers for services via different RATs/CNs. In some examples, UE 101 may be a smart phone, a wearable device, an Internet of Things (IoT) device, a tablet, etc.

5GS networks are packet-switched (PS) Internet Protocol (IP) networks. When a UE joins an evolved packet system (EPS) network, a Packet Data Network (PDN) address (i.e., the one that can be used on the PDN) is assigned to the UE for its connection to the PDN. In 4G, EPS has defined a Default EPS Bearer to provide the IP Connectivity that is Always-On. In 5G, a PDU session establishment procedure is a parallel procedure of a PDN connection procedure in 4G. A PDU session defines the association between the UE and the data network that provides a PDU connectivity service. Each PDU session is identified by a PDU session ID, and may include multiple QoS flows and QoS rules.

Each PDU session can be established over a 3GPP RAN, or over a non-3GPP RAN for radio access. 5G session management (5GSM) for PDU sessions over both 3GPP access and non-3GPP access are managed by AMF and SMF via NAS signaling. Operators are seeking ways to balance data traffic between mobile networks and non-3GPP access in a way that is transparent to users and reduces mobile network congestion. In 5GS, UEs that can be simultaneously connected to both 3GPP access and non-3GPP access (using 3GPP NAS signalling), thus the 5GS is able to take advantage of these multiple accesses to improves the user experience, and optimize the traffic distribution across various accesses. Accordingly, 3GPP introduced MA PDU sessions in 5GS. An MA PDU session uses one 3GPP access network or one non-3GPP access network at a time, or simultaneously one 3GPP access network and one non-3GPP access network.

MA PDU sessions can be established over both 3GPP access and non-3GPP access simultaneously, or one at a time. For established MA PDU sessions, the 5GS can initiate a PDU session release procedure to release one specific access type or both access types for an MA PDU session. However, when a UE-requested MA PDU session establishment procedure and a network-requested MA PDU session release procedure collide, UE behavior is undefined. For example, an MA PDU session is established over a first access type. UE then initiates a PDU session establishment procedure over a second access type, while 5GS initiate a PDU session release procedure to release a specific access type of the same MA PDU session.

In accordance with one novel aspect, explicit UE behaviors are proposed to handle a collision of the UE-requested MA PDU session establishment procedure and the network-requested MA PDU session release procedure (as depicted by 130). The collision is detected if the UE 101 receives a PDU SESSION RELEASE COMMAND message after sending a PDU SESSION ESTABLISHMENT REQUEST message to the network, and the PDU session ID in the PDU SESSION RELEASE COMMAND message is the same as the PDU session ID in the PDU SESSION ESTABLISHMENT REQUEST message. If the UE-requested PDU session establishment procedure was to establish user plane resources on the second access type for an MA PDU session already established on a first access and the Access type IE is not included in the PDU SESSION RELEASE COMMAND or the Access type IE included in the PDU SESSION RELEASE COMMAND indicates the first access, then as depicted by 140, UE 101 proceeds with the network-requested PDU session release procedure for releasing the MA PDU session, aborts the UE-requested PDU session establishment procedure, stops timer T3580, releases the allocated PTI, and enters the state PROCEDURE TRANSACTION INACTIVE. Otherwise, as depicted by 150, UE 101 ignores the PDU SESSION RELEASE COMMAND message and proceeds with the UE-requested PDU session establishment procedure for establishing the MA PDU on the second access type.

FIG. 2 illustrates simplified block diagrams of wireless devices, e.g., a UE 201 and a network entity 211 in accordance with embodiments of the current invention. Network entity 211 may be a base station and/or an AMF/SMF. Network entity 211 has an antenna 215, which transmits and receives radio signals. A radio frequency RF transceiver module 214, coupled with the antenna, receives RF signals from antenna 215, converts them to baseband signals and sends them to processor 213. RF transceiver 214 also converts received baseband signals from processor 213, converts them to RF signals, and sends out to antenna 215. Processor 213 processes the received baseband signals and invokes different functional modules to perform features in base station 211. Memory 212 stores program instructions and data 220 to control the operations of base station 211. In the example of FIG. 2, network entity 211 also includes protocol stack 280 and a set of control function modules and circuits 290. Protocol stacks 280 includes Non-Access-Stratum (NAS) layer to communicate with an AMF/SMF/MME entity connecting to the core network, Radio Resource Control (RRC) layer for high layer configuration and control, Packet Data Convergence Protocol/Radio Link Control (PDCP/RLC) layer, Media Access Control (MAC) layer, and Physical (PHY) layer. In one example, control function modules and circuits 290 includes PDU session handling circuit 291 that handles PDU establishment, modification, and release procedures, and configuration and control circuit 292 that provides different parameters to configure and control UE of related functionalities including mobility management and PDU session management.

Similarly, UE 201 has memory 202, a processor 203, and radio frequency (RF) transceiver module 204. RF transceiver 204 is coupled with antenna 205, receives RF signals from antenna 205, converts them to baseband signals, and sends them to processor 203. RF transceiver 204 also converts received baseband signals from processor 203, converts them to RF signals, and sends out to antenna 205. Processor 203 processes the received baseband signals and invokes different functional modules and circuits to perform features in UE 201. Memory 202 stores data and program instructions 210 to be executed by the processor to control the operations of UE 201. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines. A processor in associated with software may be used to implement and configure features of UE 201.

UE 201 also includes protocol stacks 260 and a set of control function modules and circuits 270. Protocol stacks 260 includes NAS layer to communicate with an AMF/SMF/MME entity connecting to the core network, RRC layer for high layer configuration and control, PDCP/RLC layer, MAC layer, and PHY layer. Control function modules and circuits 270 may be implemented and configured by software, firmware, hardware, and/or combination thereof. The control function modules and circuits, when executed by the processors via program instructions contained in the memory, interwork with each other to allow UE 201 to perform embodiments and functional tasks and features in the network.

In one example, control function modules and circuits 270 includes a PDU session handling circuit 271 that performs MA PDU session establishment, modification, and release procedures with the network, and a config and control circuit 272 that handles configuration and control parameters for mobility management and session management. Upon detecting a collision between a UE-requested MA PDU session establishment procedure and a network-requested MA PDU session release procedure, UE decides whether to proceeds with the network-requested PDU session release procedure and aborts the UE-requested PDU session establishment procedure, or ignores the PDU SESSION RELEASE COMMAND message and proceeds with the UE-requested PDU session establishment procedure.

An MA PDU session in 5GS can be established after a UE is registered to the network over both 3GPP and non-3GPP access type belonging to the same PLMN. The UE establishes a MA PDU session by initiating a PDU session establishment procedure with the network over either 3GPP or non-3GPP access type and activating the MA PDU session with user plane resources established over both accesses in a single step. The activation of the MA PDU connectivity service refers to the establishment of user-plane resources on both 3GPP access and non-3GPP access. In another embodiment, the UE is registered to the network over both 3GPP and non-3GPP access type belonging to different PLMNs. The MA PDU session is first established over one access type and then established over another access type in two separate steps. In yet another embodiment, the UE registers to the network over 3GPP access and non-3GPP access type belonging to the same PLMN and establishes the MA PDU session to the same PLMN over both 3GPP access type and non-3GPP access type in two separate steps. A MA PDU session uses one 3GPP access network or one non-3GPP access network at a time, or simultaneously one 3GPP access network and one non-3GPP access network. In addition, the UE and the network can support Access Traffic Steering Switching and Splitting (ATSSS) functionalities to distribute traffic over 3GPP access and non-3GPP access for the established MA PDU session. An MA PDU session is active when user plane resources of the MA PDU session are established over at least one access type.

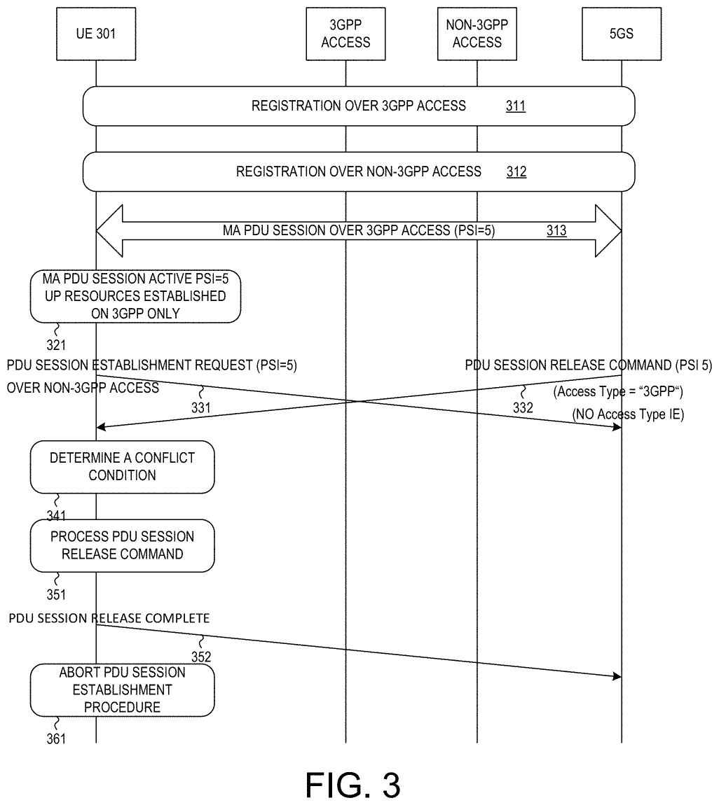

FIG. 3 illustrates one embodiment of MA PDU session establishment handling when UE also receives a PDU session release command from the network in accordance with one novel aspect. In step 311, UE 301 registers with the 5GS network over 3GPP access type. In step 312, UE 301 registers with the 5GS network over non-3GPP access type. In step 313, UE 301 initiates a PDU session establishment procedure by sending a PDU SESSION ESTABLISHMENT REQUEST message over 3GPP access type, to establish an MA PDU session with a request type IE set to “MA PDU request” and with PSI=5. UE 301 then receives a PDU SESSION ESTABLISHMENT ACCEPT message from the 5GS network over 3GPP access type, which carries Access Traffic Steering Switching and Splitting (ATSSS) rule. In step 321, the MA PDU session with PSI=5 is established between UE 301 and the 5GS network over 3GPP access types. The MA PDU session with PSI=5 is active, and user plane resources are established on 3GPP access only.

In step 331, UE 301 triggers a UE-requested PDU session establishment procedure by sending a PDU SESSION ESTABLISHMENT REQUEST message over non-3GPP access type, for the MA PDU (PSI=5). In step 332, UE 301 receives a PDU SESSION RELEASE COMMAND message for the same MA PDU (PSI=5), after the PDU session establishment procedure is triggered, but before the procedure is completed. In step 341, UE 301 determines a conflict condition for the UE-requested PDU session establishment procedure caused by the network-requested PDU session release procedure. The UE-requested PDU session establishment procedure is to establish user plane resources on non-3GPP access type for the MA PDU session (PSI=5) that is already established on 3GPP access. A conflict condition is satisfied under the following scenarios, when the UE detects the network's intention of releasing the existing MA PDU (PSI=5). In a first scenario, the Access type IE is not included in the PDU SESSION RELEASE COMMAND. In a second scenario, the Access type IE included in the PDU SESSION RELEASE COMMAND indicates 3GPP access. Under both scenarios, the network-requested PDU session procedure is valid and should have higher priority than the UE-requested PDU session establishment procedure. Therefore, in step 351, UE 301 decides to proceed with the network-requested PDU session release procedure for releasing the MA PDU session. In step 352, UE 301 sends a PDU SESSION RELEASE COMPLETE message to 5GS. In step 361, UE 301 aborts the UE-requested PDU session establishment procedure, stops timer T3580, releases the allocated PTI, and enters the state PROCEDURE TRANSACTION INACTIVE. The order of Steps 351, 352 and 361 can be different, e.g., the step 361 can be done by the UE 301 firstly and the step 351 can be done by the UE 301 secondly.

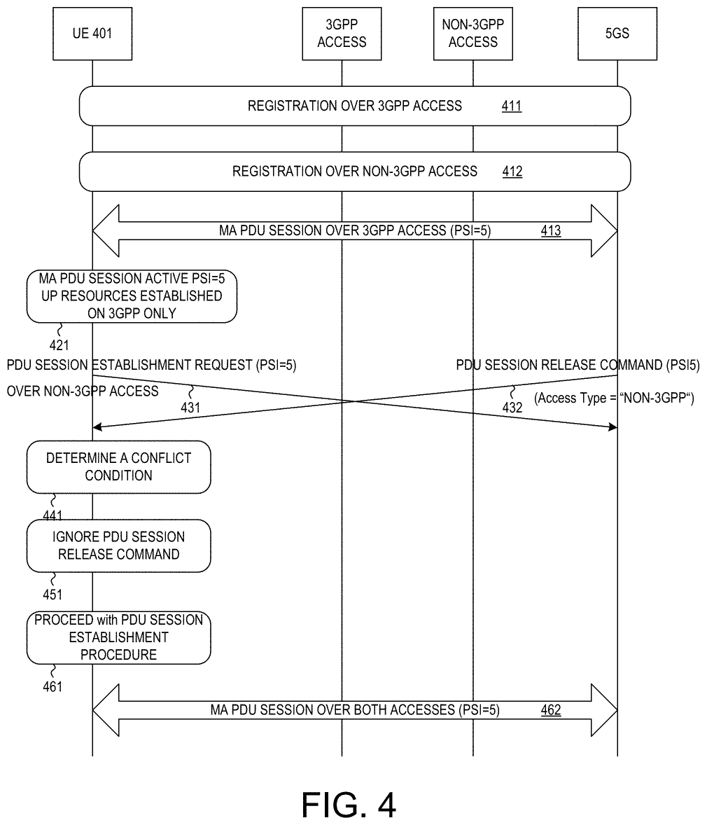

FIG. 4 illustrates another embodiment of MA PDU session establishment handling when UE also receives a PDU session release command from the network in accordance with one novel aspect. Steps 411 to 421 are similar to steps 311 to 321 of FIG. 3, where an MA PDU session having PSI=5 is established over 3GPP access. In step 431, UE 401 triggers a UE-requested PDU session establishment procedure by sending a PDU SESSION ESTABLISHMENT REQUEST message over non-3GPP access type, for the MA PDU (PSI=5). In step 432, UE 401 receives a PDU SESSION RELEASE COMMAND message for the same MA PDU (PSI=5), after the PDU session establishment procedure is triggered, but before the procedure is completed.

In step 441, UE 401 determines a conflict condition for the UE-requested PDU session establishment procedure caused by the network-requested PDU session release procedure. The UE-requested PDU session establishment procedure is to establish user plane resources on non-3GPP access type for the MA PDU session (PSI=5) that is already established on 3GPP access. A conflict condition is not satisfied under the following scenarios, when the UE detects the network-requested PDU session release might be an error. For example, the Access type IE included in the PDU SESSION RELEASE COMMAND indicates non-3GPP access, while the current MA PDU does not have user plane resources established over non-3GPP access. As a result, in step 451, UE 401 decides to ignore the network-requested PDU session release procedure for releasing the MA PDU session. In step 461, UE 401 decides to proceed with UE-requested PDU session establishment procedure. In step 462, the MA PDU session (PSI=5) is established over both 3GPP and non-3GPP access types.

In an alternative embodiment, for a single-access PDU (SA PDU) session, if a UE-requested PDU session establishment procedure collides with a network-requested PDU session release procedure, then typically, the UE will also ignore the PDU SESSION RELEASE COMMAND message and proceed with the UE-requested PDU session establishment procedure.

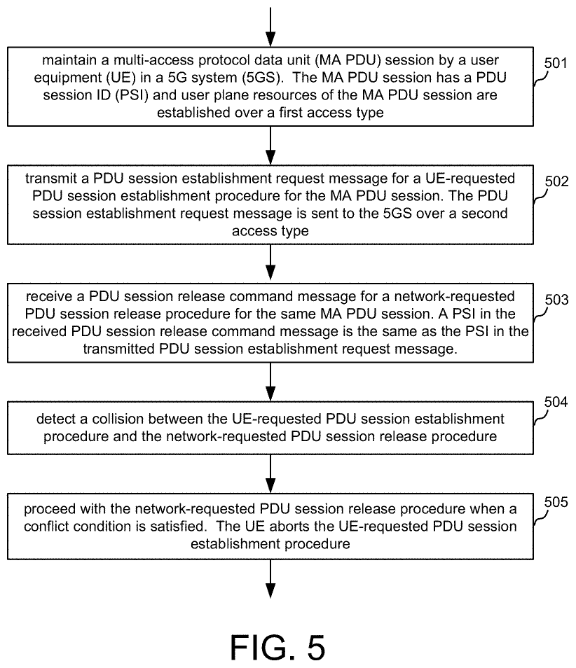

FIG. 5 is a flow chart of a method of handling MA PDU session establishment in accordance with one novel aspect of the present invention. In step 501, a UE maintains a multi-access protocol data unit (MA PDU) session in a 5G system (5GS). The MA PDU session has a PDU session ID (PSI) and user plane resources of the MA PDU session are established over a first access type. In step 502, the UE transmits a PDU session establishment request message for a UE-requested PDU session establishment procedure for the MA PDU session. The PDU session establishment request message is sent to the 5GS over a second access type. In step 503, the UE receives a PDU session release command message for a network-requested PDU session release procedure for the same MA PDU session. A PSI in the received PDU session release command message is the same as the PSI in the transmitted PDU session establishment request message. In step 504, the UE detects a collision between the UE-requested PDU session establishment procedure and the network-requested PDU session release procedure. In step 505, the UE proceeds with the network-requested PDU session release procedure when a conflict condition is satisfied, and aborts the UE-requested PDU session establishment procedure.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
maintaining a multi-access protocol data unit (MA PDU) session by a user equipment (UE) in a 5G system (5GS), wherein the MA PDU session has a PDU session ID (PSI) and user plane resources of the MA PDU session are established over a first access type;
transmitting a PDU session establishment request message for a UE-requested PDU session establishment procedure for the MA PDU session, wherein the PDU session establishment request message is sent to the 5GS over a second access type;
receiving a PDU session release command message for a network-requested PDU session release procedure for the same MA PDU session, wherein a PSI in the received PDU session release command message is the same as the PSI in the transmitted PDU session establishment request message;
detecting a collision between the UE-requested PDU session establishment procedure and the network-requested PDU session release procedure; and
proceeding with the network-requested PDU session release procedure when a conflict condition is satisfied, wherein the UE aborts the UE-requested PDU session establishment procedure.

2. The method of claim 1, wherein the UE-requested PDU session establishment request procedure is to request to establish user plane resources on the second access type for the MA PDU session.

3. The method of claim 1, wherein the conflict condition is satisfied when the PDU session release command message comprises an access type information element (IE) indicating the first access type.

4. The method of claim 1, wherein the conflict condition is satisfied when the PDU session release command message does not carry an access type information element.

5. The method of claim 1, wherein the network-requested PDU session release procedure involves UE transmitting a PDU session release complete message or a 5G session management (5GSM) status message to the 5GS.

6. The method of claim 1, wherein the aborting of the UE-requested PDU session establishment procedure involves UE stopping timer T3580, releasing an allocated PTI, and entering PROCEDURE TRANSACTION INACTIVE state.

7. The method of claim 1, wherein the UE determines that the conflict condition is not satisfied when the PDU session release command message comprises an access type information element (IE) indicating the second access type.

8. The method of claim 7, wherein the UE ignores the PDU session release command message when the conflict condition is not satisfied.

9. The method of claim 7, wherein the UE proceeds with the UE-requested PDU session establishment procedure when the conflict condition is not satisfied.

10. The method of claim 1, wherein the UE determines that the conflict condition is not satisfied when the MA PDU session becomes a single-access PDU (SA PDU) session.

11. A User Equipment (UE), comprising:
a protocol data unit (PDU) session handling circuit that maintains a multi-access PDU (MA PDU) session in a 5G system (5GS), wherein the MA PDU session has a PDU session ID (PSI) and user plane resources of the MA PDU session are established over a first access type;
a transmitter that transmits a PDU session establishment request message for a UE-requested PDU session establishment procedure for the MA PDU session, wherein the PDU session establishment request message is sent to the 5GS over a second access type;
a receiver that receives a PDU session release command message for a network-requested PDU session release procedure for the same MA PDU session, wherein a PSI in the received PDU session release command message is the same as the PSI in the transmitted PDU session establishment request message; and
a control circuit that detects a collision between the UE-requested PDU session establishment procedure and the network-requested PDU session release procedure, wherein the UE proceeds with the network-requested PDU session release procedure when a conflict condition is satisfied, and wherein the UE aborts the UE-requested PDU session establishment procedure.

12. The UE of claim 11, wherein the UE-requested PDU session establishment request procedure is to request to establish user plane resources on the second access type for the MA PDU session.

13. The UE of claim 11, wherein the conflict condition is satisfied when the PDU session release command message comprises an access type information element (IE) indicating the first access type.

14. The UE of claim 11, wherein the conflict condition is satisfied when the PDU session release command message does not carry an access type information element.

15. The UE of claim 11, wherein the network-requested PDU session release procedure involves UE transmitting a PDU session release complete message or a 5G session management (5GSM) status message to the 5GS.

16. The UE of claim 11, wherein the aborting of the UE-requested PDU session establishment procedure involves UE stopping timer T3580, releasing an allocated PTI, and entering PROCEDURE TRANSACTION INACTIVE state.

17. The UE of claim 11, wherein the UE determines that the conflict condition is not satisfied when the PDU session release command message comprises an access type information element (IE) indicating the second access type.

18. The UE of claim 17, wherein the UE ignores the PDU session release command message when the conflict condition is not satisfied.

19. The UE of claim 17, wherein the UE proceeds with the UE-requested PDU session establishment procedure when the conflict condition is not satisfied.

20. The UE of claim 11, wherein the UE determines that the conflict condition is not satisfied when the MA PDU session becomes a single-access PDU (SA PDU) session.
